(19) United States
(12) Patent Application Publication
(10) Pub. No.: US 2008/0259797 A1
(43) Pub. Date: Oct. 23, 2008

(54) Load-Balancing Bridge Cluster For Network Nodes

(75) Inventors: Shimon Gruper, Haifa (IL); Yanki Margalit, Ramat Gan (IL); Dany Margalit, Ramat Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN KNOWLEDGE SYSTEMS LTD., Petach Tikva (IL)

(21) Appl. No.: 11/736,604

(22) Filed: Apr. 18, 2007

(51) Int. Cl. H04J 1/16

(52) U.S. Cl. 370/235; 370/465

(57) ABSTRACT

A network load-balancing cluster configured to function as a transparent bridge, by connecting the load-balancing nodes in series rather than in parallel, as is done in prior-art configurations. A load-balancing algorithm and method are disclosed, by which each node in the configuration independently determines whether to process a data packet or pass the data packet along for processing by another node. To support this, load-balancing nodes are equipped with both software and hardware data pass-through capabilities that allow the nodes to pass along data packets that are processed by a different nodes.

### FIELD OF THE INVENTION

The present invention relates to data network load balancing and, more particularly, to a load balancing for network nodes such as servers and gateways.

### BACKGROUND OF THE INVENTION

In many network implementations, nodes such as servers and gateways are clustered in parallel in a redundant configuration to provide increased availability and reliability, and to prevent data traffic congestion, by distributing the workload among a set of nodes according to criteria which optimize the overall data throughput.

The term “node” herein denotes any point within a network where data processing may be performed, including, but not limited to: servers; gateways; and similar devices.

The term “load balancing” herein denotes the distribution of data processing load among a set of nodes for purposes including, but not limited to: preventing data traffic congestion; reducing processing latency; increasing processing availability; and increasing processing reliability. Distribution of data processing load can be accomplished by means including, but not limited to: assigning the processing of a particular data item to a specific device; directing a specific data item to a specific network device for processing; and determining whether a particular device is to process a particular data item.

FIG. 1 illustrates such a configuration, where clients 101a, 101b, 101c, and 101d are connected to a network switch 103, which supports data connections to nodes 105a, 105b, 105c, and 105d. A network switch 107 supports data connections from the foregoing nodes to a wide-area network 111 such as the Internet, through a firewall 109. Nodes 105a, 105b, 105c, and 105d may be, for example, gateways providing content security services by inspecting traffic between clients 101a, 101b, 101c, and 101d and network 111.

The term “switch” herein denotes any device which is capable of directing data traffic in a selectable manner to one or more other devices. The term “switch” is thus used herein in a non-limiting fashion to identify certain devices which perform switching functions and may therefore be implemented in various ways, such as by the use of devices generally referred to as “routers”.

FIG. 1 illustrates the prior-art configuration, which is denoted herein as a “parallel” configuration; in such a configuration, the load-balancing nodes are also said to be connected “in parallel”. A determining characteristic of a parallel configuration of load-balancing nodes is that a data packet passing through a parallel-configured load-balancing cluster passes through exactly one and only one of the load-balancing nodes.

Because nodes 105a, 105b, 105c, and 105d are connected to network switch 103 rather than a hub, only one node can see the traffic at a time. Hubs, however, are no longer preferred, because they operate in half-duplex mode at limited speed and cannot be freely cascaded.

In a prior-art configuration such as illustrated in FIG. 1, the different nodes may be dedicated to perform different specific functions and thereby distribute the data processing load among several nodes; alternatively, a particular node may be dedicated to function as a master node which distributes traffic to other nodes for processing, and thereby achieve load balancing. In such a configuration there is typically a heartbeat protocol among the nodes, so that if one node fails the master node will know not to send traffic to that node; and if the master node fails, one of the other nodes can be predetermined to take over master node responsibility.

A practical limitation of the parallel load-balancing node configuration shown in FIG. 1 is that such a configuration does not function as a transparent bridge, but must function as a router.

There is thus a need for, and it would be highly advantageous to have, a load-balancing configuration for network nodes that functions as a transparent bridge rather than as a router. This goal is met by the present invention.

### SUMMARY OF THE INVENTION

The present invention is of a cluster of nodes in a bridge configuration, for network load-balancing. According to embodiments of the present invention, two or more load-balancing nodes are connected in series, in contrast to prior-art configurations in which nodes are connected in parallel. In this manner, load-balancing configurations according to embodiments of the present invention function as a transparent bridge, and do not have to be set up as a router. The advantages of the bridge configuration include, but are not limited to easier installation. This is an important benefit, for it is realized in the prior art that the difficulties of setting up and administering prior-art clusters for load-balancing has discouraged some users from employing them.

To support the bridge configuration, nodes according to embodiments of the present invention possess data pass-through capabilities (also denoted as “bypass”), whereby a node may process data traffic or pass the data traffic through unprocessed. A load-balancer within the node makes the decision to process or pass-through, based on predetermined criteria; a data-handler performs the processing on data traffic that is not passed through. The term “load-balancer” herein denotes any system, device, component, or programmed facility thereof which is capable of selectively determining whether or not a particular data processor should process a particular data item.

A general objective of a load-balancing cluster according to the present invention is to improve the efficiency of data processing by distributing the processing load over multiple data processors.

Another general objective of a load-balancing cluster according to the present invention is to increase the availability of processors and hence to increase the reliability of the cluster. Still another general objective of a load-balancing cluster according to the present invention is to provide for fault tolerance and redundant backup processing in the event of node failure.

It is understood and will be appreciated by those familiar with the art that a load-balancing cluster according to the present invention operates to accomplish all of the above goals.

Therefore, according to the present invention there is provided a load-balancing cluster for a data network including a plurality of load-balancing nodes connected in series, wherein each of the load-balancing nodes includes: (a) A first external data port for receiving a data packet; (b) A second external data port for retransmitting the data packet; (c) a data handler for processing the data packet; and (d) a load balancer for determining whether to process the data packet by the data handler.

### BRIEF DESCRIPTION OF THE DRAWINGS

The invention is herein described, by way of example only, with reference to the accompanying drawings, wherein:

FIG. 1 illustrates a typical prior-art network load-balancing configuration.

FIG. 2 illustrates a non-limiting example of a network load-balancing configuration according to embodiments of the present invention.

FIG. 3 is a block diagram conceptually illustrating a load-balancing network node according to embodiments of the present invention.

FIG. 4 is a flowchart illustrating a load-balancing and data pass-through method according to an embodiment of the present invention.

### DESCRIPTION OF THE PREFERRED EMBODIMENTS

The principles and operation of a network load-balancing configuration according to the present invention may be understood with reference to the drawings and the accompanying description.

### Series Configuration

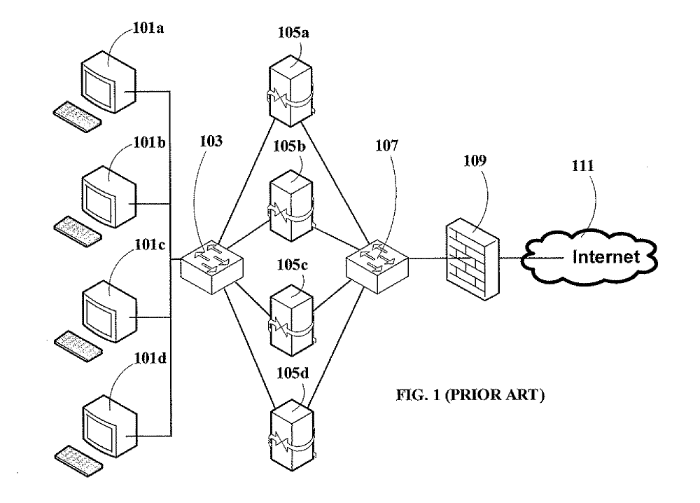

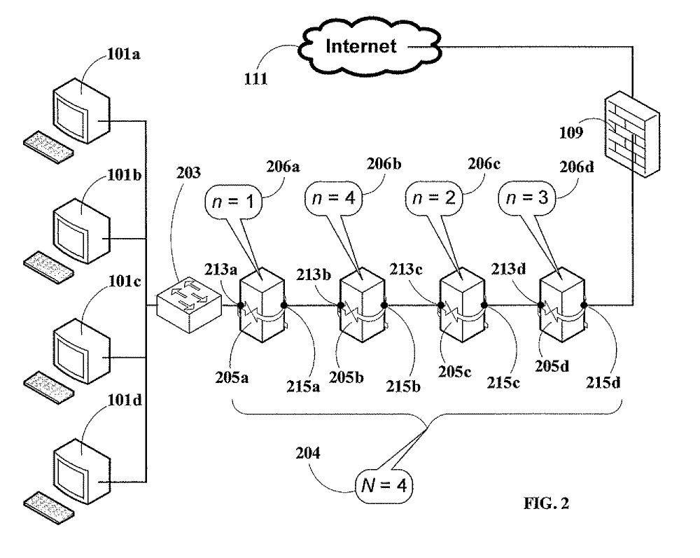

FIG. 2 illustrates a non-limiting example of a network load-balancing configuration according to embodiments of the present invention. As with a typical prior-art configuration (FIG. 1) clients 101a, 101b, 101c, and 101d are connected ultimately to wide-area 111 through firewall 109. However, only a single switch 203 is needed, because nodes 205a, 205b, 205c, and 205d are connected in series, rather than in parallel, as with prior-art nodes 105a, 105b, 105c, and 105d (FIG. 1). The term “cluster” herein denotes a multiplicity of network devices which are interconnected to accomplish a unified goal. The configurations of the prior art, as well as of the present invention, are commonly referred to as clusters.

FIG. 2 illustrates the configuration of the present invention, which is denoted herein as a “series” configuration; in such a configuration of at least two nodes, the load-balancing nodes are also said to be connected “in series” A determining characteristic of a series configuration of load-balancing nodes is that a data packet passing through a series-configured load-balancing cluster consecutively passes through each of the load-balancing nodes. This is distinct from the corresponding characteristic of a parallel-configured load-balancing cluster, as previously described, wherein a data packet passes through exactly one and only one of the load-balancing nodes.

Another determining characteristic is the topology of the series configuration, wherein exactly two load-balancing nodes are at the ends of the series configuration, and are herein denoted as “end-nodes”. In FIG. 2, node 205a and node 205d are the end-nodes. End-nodes are distinguished by the fact that they are connected to exactly one and only one other load-balancing node of the series configuration (node 205a is connected to node 205b and to only node 205b of the cluster; and node 205d is connected to node 205c and to only node 205c of the cluster). With the exception of the end-nodes, however, each load-balancing node of the series configuration is connected to exactly two other load-balancing nodes of the configuration. In FIG. 2, node 205b and node 205c are the load-balancing nodes of the configuration which are not end-nodes (node 205b is connected both to node 205a and to node 205c; and node 205c is connected both to node 205b and to node 205d).

Thus, switch 203 is required to handle a multiplicity of clients rather than a multiplicity of nodes, as is necessary in prior-art configurations (FIG. 1). According to embodiments of the present invention, nodes 205a, 205b, 205c, and 205d perform load-balancing in the series configuration, as detailed below.

In embodiments of the present invention, each of the nodes 205a, 205b, 205c, and 205d is associated with a node number, which is an integer herein denoted by n. The total number of active nodes is denoted herein by N, as discussed in further detail below in the section “Load-Balancing Node Enumeration”. The integers n range from 1 (inclusive) to N (inclusive) and are assigned uniquely within a cluster, so that there is a one-to-one mapping between the N nodes of a cluster and the integers 1 . . . N. The nodes, however, need not be sequentially numbered according to their connections.

A non-limiting example of the above is shown in FIG. 2. Node 205a has an association 206a with the integer n 1; node 205b has an association 206b with the integer n=4; node 205c has an association 206c with the integer n=2; and node 205d has an association 206d with the integer n=3. Thus, in this non-limiting example, the four nodes have a one-to-one mapping with the integers 1, 2, 3, 4; but they are not numbered sequentially. In this non-limiting example, the total number of load-balancing nodes, denoted as N has an enumeration 204 of 4.

### Internal and External Ports

The serial connections are to the external ports of nodes 205a, 205b, 205c, and 205d as illustrated in FIG. 2. The term “external port” herein denotes a data port of a node which may be directly accessed externally to the node via a connection thereto, for sending and receiving data to and from other nodes.

The terms “connection”, “connected”, and variants thereof herein denote a direct data link, or the equivalent thereof via an external data port of a device to a respective external data port of an attached device. Although data can freely travel indirectly via the network from any device on the network to any other device on the network, only those devices which are immediately attached by a direct data link, or the equivalent thereof via their respective external data ports are considered to have a “connection” and to be “connected”.

Switch 203 is connected to an external port 213a of node 205a; an external port 215a of node 205a is connected to an external port 213b of node 205b; an external port 215b of node 205b is connected to an external port 213c of node 205b; an external port 215c of node 205c is connected to an external port 213d of node 205d; and an external port 215d of node 205d is connected to wide-area network 111 through firewall 109.

In preferred embodiments of the present invention, a load-balancing node has two separate external data ports.

### Pass-Through Data Adapter

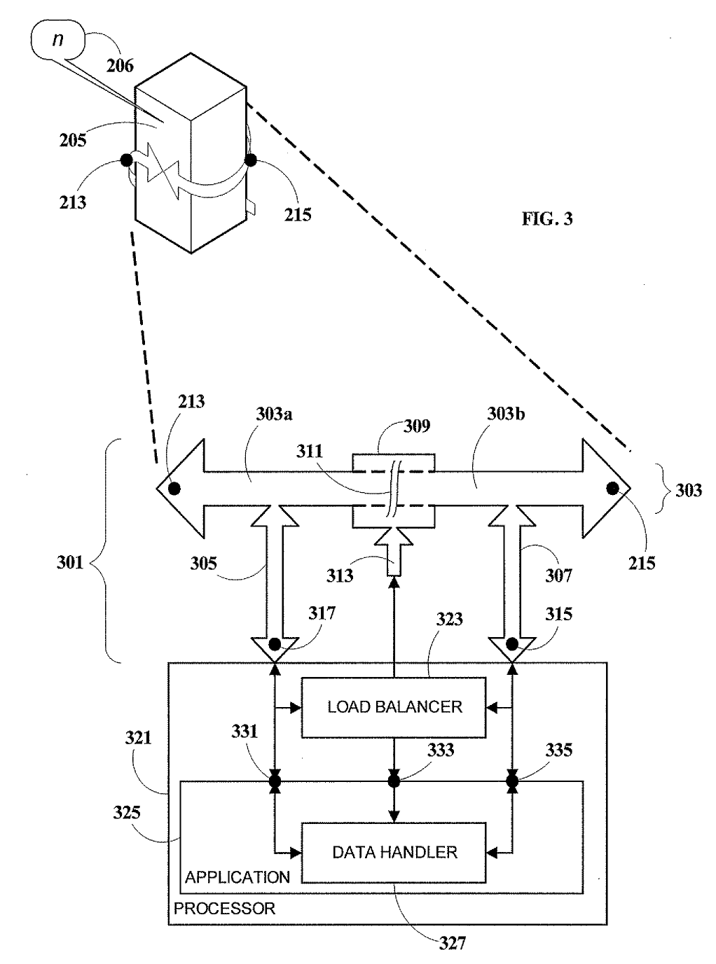

The block diagram of FIG. 3 conceptually illustrates a load-balancing network node 205, according to embodiments of the present invention. Node 205 may be any of nodes 205a, 205b, 205c, and 205d (FIG. 2).

Functionally, node 205 contains a pass-through data communications adapter 301, which is capable of passing data traffic through directly from an external port 213 to an external port 215 via an internal data path 303. External port 213 may be any of external ports 213a, 213b, 213c, and 213d (FIG. 2); and external port 215 may be any of external ports 215a, 215b, 215c, and 215d (FIG. 2). Adapter 301 has a hardware data pass-through mode that can be enabled to perform the passing of data traffic as just described. The pass-through mode is covered in more detail below.

It is noted that the internal communication paths of adapter 301 (as detailed below) are fill-duplex paths, wherein data traffic can travel in either direction at any time, as well as in both directions simultaneously. In a non-limiting example, data may travel between external port 213 and an internal port 317 via a full-duplex data path 305; and between external port 215 and an internal port 315 via a full-duplex port 307. The term “internal port” herein denotes a data port of a node which is not directly accessible externally to the node, but which is directly-accessible only within the node by internal components thereof, via internal connections to the internal port. In a non-limiting example as shown in FIG. 2, node 205b can directly access external port 215a of node 205a, but node 205b cannot directly access an internal port of node 205a.

Returning to FIG. 3, adapter 301 also contains a hardware data pass-through controller 309 with a controller input 313. Controller 309 is capable of breaking internal data path 303 into two distinct sections, a data path 303a and a data path 303b, as shown, by engaging a hardware isolator 311 that separates data path 303a from data path 303b when controller 309 disables the data pass-through mode. Data paths 303a and 303b are both full-duplex paths. When controller 309 enables the hardware data pass-through mode, hardware isolator 311 is functionally removed so that data path 303a and data path 303b are physically united and function as a single data path 303 that connects external data port 213 to external data port 215 for full-duplex operation as previously described.

In an embodiment of the present invention, the hardware data pass-through mode described above is provided to handle data pass-through in cases of node failure, including, but not limited to: electrical power failure; and system malfunction. In another embodiment of the present invention, the hardware data pass-through mode is provided to handle data pass-through under software control via controller input 313, when it is programmatically desired to perform data pass-through at a node.

### Hardware Data Pass-Through Adapter

A hardware device suitable for use as data pass-through adapter 301 (herein denoted as a “hardware data pass-through adapter”) is currently available through regular commercial sources. Such devices include the “Gigabit Ethernet Bypass Server Adapter” series manufactured by Silicom Connectivity Solutions Ltd., 8 Hanagar St., Kfar Sava, Israel, with U.S. offices at 6 Forest Ave., Paramus, N.J. 07652. Models include fiber-optic as well as copper hardware data pass-through circuitry. Using a hardware data pass-through adapter, a hardware data pass-through mode can be activated in a load-balancing node upon a host system failure, loss of power, or upon software request, as detailed above via input 313. In a hardware data pass-through, the connections of Ethernet network ports 213 and 215 are disconnected from their respective internal interfaces 317 and 315, and are switched over to the opposite port to create a crossed connection loop-back between Ethernet ports 213 and 215. The hardware pass-through mode, as described above, where data packets travel through the adapter without processing, is also referred to as the “failed open state” or the “transparent state” of the adapter.

In hardware data pass-through mode, all packets received at one port (i.e., port 213 or port 215) are routed by the hardware data pass-through adapter directly for re-transmission to the opposite port (i.e., port 215 or port 213, respectively). The hardware data pass-through mode can also be initiated by a software command. The term “packet” herein denotes a network data packet as commonly understood in the art.

### Node Processor

When adapter 301 is not in the hardware data pass-through mode, data traveling between external port 215 and external port 213 is routed through a processor 321, which processes the data, according to embodiments of the present invention. The term “processor” herein denotes any device or system capable of processing data. The terms “process”, “processing”, and variants thereof herein denote all manner of operations involving data, including, but not limited to: mathematical operations; logical operations; comparison operations; decisions; data interpretation and analysis; intermediate operations; data creation; write operations; read/write operations; and read-only operations which do not modify the data in any way.

According to embodiments of the present invention, functional processing of data to perform the data functions intended for node 205 are handled by an application 325, which contains a data handler 327 for processing data according to a predefined task or other requirements. The terms “application” and “software application” are herein synonymous and herein denote executable computer code which, when executed on a processor or other data device, performs a desired processing of data.

A packet of data can be sent to application 325 for handling via the TCP/IP stack. In certain embodiments of the present invention, data handler 327 is a hardware device which performs application 325, and in some such embodiments, data handler 327 includes a hardware controller. In certain other embodiments, data handler 327 is a software program that includes executable computer code for performing application 325. In yet other embodiments of the present invention, data handler 327 contains both hardware and software for performing application 325.

In embodiments of the present invention, application 325 has bi-directional data interfaces (or ports) 331 and 335. In other embodiments, application 325 also has an input control interface (or port) 333. In embodiments of the present invention, data communication between internal ports 317, 315 and data handler 327 is via application bi-direction interfaces 331, 335 respectively. Equivalently, other embodiments feature direct data communication between internal ports 317, 315 and data handler 327.

### Load-Balancing Node

According to embodiments of the present invention, processor 321 includes a load balancer 323, which determines, on a packet-by-packet basis, whether to handle incoming data, or to pass the incoming data through without handling (by data pass-through, as detailed above). The objective of load balancer 323 is to distribute the processing load over the different load-balancing nodes of a cluster to attain more efficient processing and to reduce or eliminate data processing bottlenecks caused by overloading a processor.

According to embodiments of the present invention, load balancer 323 performs several related functions to implement efficient and effective load-balancing. These functions include, but are not limited to: load-balancing node enumeration; and load-balancing decision-making. These functions are described in detail below.

It is noted that, according to embodiments of the present invention, each node of a load-balancing cluster independently determines whether to process a given data packet or to pass that data packet along for processing by another node; such determinations are made in an identical way by each node independently. Load-balancing clusters according to embodiments of the present invention do not have a dedicated master node, as is required in prior-art load-balancing configurations. In this manner, load-balancing clusters according to embodiments of the present invention distribute the processing load without giving a special status to any one node.

### Processing of Data Packets

In embodiments of the present invention, a data packet is processed by not more than one load-balancing node of the configuration (as in the configuration of FIG. 2). That is, in these embodiments having a cluster of N load-balancing nodes, at least N−1 nodes simply perform a data pass-through without processing (as detailed herein).

In certain embodiments of the present invention, a data packet is processed by the data handler (such as data handler 327 in FIG. 3) of exactly one load-balancing node of the configuration.

In other embodiments of the present invention, it is possible for a data packet to be processed by more than one load-balancing node of the configuration. In a non-limiting example, one load-balancing node performs a spyware check on a data packet, and another load-balancing node performs a virus check on the same data packet.

In various embodiments of the present invention, it is possible for a data packet to pass through the entire configuration of N load-balancing nodes without being processed by a data handler. As previously noted, because the configuration is a series configuration, such a packet passes through each and every one of the N load-balancing nodes.

### Software Data Pass-Through

In embodiments of the present invention, data pass-through is accomplished via a software data pass-through mode, which is independent of the hardware data pass-through operation described above.

With reference to FIG. 3, when a load-balancing node is in the software data pass-through mode, a packet is passed unchanged through node 205 by processor 321. In an embodiment of the present invention, the software data pass-through mode is accomplished by application 325, which receives a packet on internal port 317, and simply re-transmits the unchanged packet via internal port 315; or vice-versa, receiving the packet on internal port 315 and simply re-transmitting the unchanged packet via internal port 317. In another embodiment of the present invention, this software data pass-through mode receiving/retransmitting is done by data handler 327; and in still another embodiment of the present invention, this software data pass-through mode receiving/retransmitting is done by load balancer 323.

This mode of data pass-through is denoted herein as “software data pass-through” because in preferred embodiments of the present invention, this mode is implemented in software. However, even though in other certain embodiments of the present invention, data handler 327, load balancer 323, and application 325 are composed, in whole or in part, of hardware devices, this mode is still denoted as “software data pass-through”, in order to be distinguished from the “hardware data pass-through” described previously.

### Software Failure Pass-Through

In an embodiment of the present invention, there is a software watchdog which periodically polls the software in the node to detect software failures. In the event of a software failure, the watchdog causes the adapter to enter the hardware data pass-through mode, as previously discussed.

### Load-Balancing Node Enumeration

Effective load-balancing requires knowing how many load-balancing nodes are available at any given time. Therefore, according to embodiments of the present invention, it is necessary for each load-balancing node to know how many other node-balancing nodes are available.

In an embodiment of the present invention, each load-balancing node (such as nodes 205a, 205h, 205c, and 205d of FIG. 2) uses a heartbeat protocol to broadcast a heartbeat packet to all the other load-balancing nodes on a regular basis (every few milliseconds, in a non-limiting example). In this manner, each load-balancing node is constantly updated with information on the health of the other nodes, and can enumerate them to know exactly how many load-balancing nodes are currently working correctly. The number of functioning load-balancing nodes is herein denoted by N. If a load-balancing node fails, that node will not broadcast the heartbeat, and after a predefined time all remaining nodes will know that a node has failed and can immediately adjust their load-balancing node enumeration to the new value of N. Likewise, if a failed node becomes active, or if a new load-balancing node comes on-line, the other nodes will also be informed and will automatically adjust the value of N. As detailed below in the discussion of the load-balancing algorithm, this insures that the cluster continues to function correctly with the load distributed between the remaining healthy nodes.

### Load-Balancing Algorithm and Method

In certain embodiments of the present invention, all load-balancing nodes in the cluster use the same algorithm, thereby improving the potential of achieving symmetry among the load-balancing nodes.

In these embodiments of the present invention, the algorithm computes a mathematical function which returns an integer in the range from 1 to N (inclusive of 1 and N), where N is number of load-balancing nodes in the cluster, as provided above. In preferred embodiments, load-balancing is session-based, and the function's return value indicates which of the nodes handles the data traffic relating to a given session on the network. Because all of the N nodes computes the same function, each node knows precisely which data packets to process.

In embodiments of the present invention, the mathematical function return value is computed as an integer function of a session identifier for a data packet, taken modulo N+1. That is,

n=(ƒ(sessionID) mod N)+1 Equation (1)

where: n is the number of the load-balancing node (from 1 to N) which is designated to handle packets of information associated with a session identifier variable denoted as sessionID; and ƒ(sessionID) is a function whose domain is session identifiers and whose range is the integers or a subset thereof. The operator mod N results in integers ranging from 0 to N−1, hence 1 is added to attain the range from 1 to N.

In an embodiment of the present invention, a suitable session identifier is a function of both the source IP address and the destination IP address of a packet. In a related embodiment, sessionID contains both addresses. In another related embodiment, sessionID is the concatenation of these addresses. It is noted that data packets related to more than one session may have the same source and destination IP addresses, such as when the same client opens multiple sessions with the same server. In such a case, all the sessions will necessarily be handled by the same load-balancing node. In a further related embodiment, sessionID is a function of a session identifier (non-limiting examples of which are found in session tables and in web browser cookies). In this case, different sessions are not necessarily handled by the same load-balancing node (but may be handled by the same node). In yet another related embodiment, sessionID is a function of at least one IP address and a data packet session identifier, thereby distinguishing not only the session, but also the direction of the data packet (e.g., to the client from the server versus to the server from the client).

In a preferred embodiment of the present invention, the function ƒ(sessionID) in Equation (1) is a hash function of sessionID. Preferably, ƒhas values which appear to be randomly distributed, with a uniform distribution, in order to achieve an even load-balancing among the nodes. In a non-limiting embodiment of the present invention, sessionID for a data packet is a hash of at least one of the packet source IP address and the packet destination IP address concatenated with a session ID.

It is noted that different applications may assign data packets for processing in different ways. In an embodiment of the present invention, application 325 is packet-oriented, and thus treats each incoming data packet independently of other packets. In this embodiment, each packet is examined by load balancer 323 to determine if application 325 should process that packet, according to the load-balancing algorithm based on Equation (1). In another embodiment of the present invention, application 325 is session-oriented. In this embodiment, load balancer 323 examines each data packet, and if a data packet is the first packet of a session, load balancer 323 determines whether application 325 should process packets of that session, according to the load-balancing algorithm based on Equation (1). If application 325 should process the first data packet of the session, load balancer 323 uses application 325 to process all the data packets associated with that particular session without applying the load-balancing algorithm based on Equation (1) on the remaining data packets. Thus, application 325 thereby handles all the data packets of a particular session, even if N changes during the session.

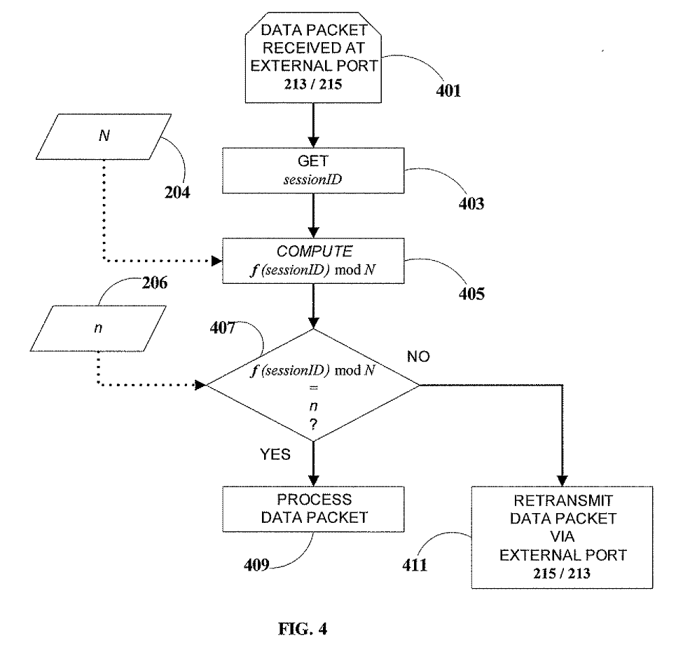

FIG. 4 is a flowchart illustrating a method for assigning the processing load, for load balancing, data pass-through, and high availability at a load-balancing network node according to an embodiment of the present invention. At a point 401, a data packet arrives at either of node external ports 213 or 215 (FIG. 3), respectively. In a step 403, the variable sessionID is obtained, and in a step 405, the function ƒ(sessionID) mod N is computed, both as described above. The enumeration 204 of N is also shown in FIG. 2. The identifying integer 206 of the node, denoted as n, as previously indicated in FIG. 3, is then compared with the computed value of ƒ(sessionID) mod N at a decision point 407. If these integers are equal, the data packet is processed by application 325 (FIG. 3) in a step 409. Otherwise, if these integers are not equal, the data packet is retransmitted in a step 411, via either of node external ports 215 or 213 (FIG. 3), respectively. It is noted that the retransmission in step 411 is done via the opposite external port from the arrival at point 401. Specifically, if the data packet arrives at port 213, the retransmission is done on port 215, and vice-versa. This is done to avoid a circular or looping condition, where a packet is continually being received and transmitted back and forth between two nodes.

### Computer Program Product

A further embodiment of the present invention provides a computer program product for performing the method previously disclosed in the present application or any variant derived therefrom. A computer program product according to this embodiment includes a set of executable commands for a computer, and is incorporated within machine-readable media including, but not limited to: magnetic media; optical media; computer memory; semiconductor memory storage; flash memory storage; and a computer network. The terms “perform”, “performing”, etc., and “run”, “running”, when used with reference to a computer program product herein denote the action of a computer when executing the computer program product, as if the computer program product were performing the actions. The term “computer” herein denotes any data processing apparatus capable of or configured for, executing the set of executable commands to perform the foregoing method, including, but not limited to the devices as previously described as denoted by the term “computer”, and as defined below.

### Additional Definitions

The term “computer” herein denotes any device or apparatus capable of executing data processing instructions, including, but not limited to: personal computers; mainframe computers; servers; workstations; data processing systems and clusters; networks and network gateways, routers, switches, hubs, and nodes; embedded systems; processors, terminals; personal digital appliances (PDA); controllers; communications and telephonic devices; and memory devices, storage devices, interface devices, smart cards and tags, security devices, and security tokens having data processing and/or programmable capabilities.

The terms “computer program”, “computer software”, “computer software program”, “software program”, “software” herein denote a collection of data processing instructions which can be executed by a computer (as defined above), including, but not limited to, collections of data processing instructions which reside in computer memory, data storage, and recordable media.

While the invention has been described with respect to a limited number of embodiments, it will be appreciated that many variations, modifications and other applications of the invention may be made.

1. A load-balancing cluster for a data network comprising a plurality of load-balancing nodes connected in series, wherein each of said load-balancing nodes includes:
A first external data port for receiving a data packet;
A second external data port for retransmitting said data packet;
a data handler for processing said data packet; and
a load balancer for determining whether to process said data packet by said data handler.

2. The load-balancing cluster of claim 1, wherein at least one load-balancing node of said plurality includes a processor containing at least one of:
said data handler;
said load balancer; and
a software application containing said data handler.

3. The load-balancing cluster of claim 2, wherein at least part of said data handler is executable code for said processor.

4. The load-balancing cluster of claim 2, wherein at least part of said load balancer is executable code for said processor.

5. The load-balancing cluster of claim 1, wherein at least one received data packet is not processed by said data handler of any load-balancing node of said plurality.

6. The load-balancing cluster of claim 1, wherein at least one received data packet is processed by said data handler of exactly one load-balancing node of said plurality.

7. The load-balancing cluster of claim 1, wherein at least one received data packet is processed by said data handler of more than one load-balancing node of said plurality.

8. The load-balancing cluster of claim 5, wherein said plurality is configured such that said data packet passes through each load-balancing node of said plurality.

9. The load-balancing cluster of claim 1, wherein:
exactly two load-balancing nodes of said plurality are end-nodes, said end-nodes being connected to exactly one other load-balancing node of said plurality, via respective external data ports thereof; and
excepting said end-nodes, each load-balancing node of said plurality is connected to exactly two other load-balancing nodes of said plurality, via respective external data ports thereof.

10. The load-balancing cluster of claim 1, wherein at least one load-balancing node of said plurality includes a hardware data pass-through adapter operative to performing a hardware data pass-through within said at least one load-balancing node.

11. The load-balancing cluster of claim 2, wherein at least one load-balancing node of said plurality is operative to performing software data pass-through.

12. The load-balancing cluster of claim 11, wherein said load balancer is operative to performing said software data pass-through.

13. The load-balancing cluster of claim 11, wherein said data handler is operative to performing said software data pass-through.

14. The load-balancing cluster of claim 11, wherein said software application is operative to performing said software data pass-through.

15. A method of assigning the processing load in a load-balancing cluster according to claim 1, the method comprising:
obtaining a count of the node-balancing load of said plurality;
assigning to each load-balancing node of said plurality a unique integer identifier ranging from 1 up to said count;
for a received data packet, evaluating a predetermined function having an integer range;
using the value of said predetermined function to determine an integer value ranging from 1 up to said count; and
processing said received data packet by the load-balancing node having a unique integer identifier equal to said integer value.

16. The method of claim 15, further comprising:
retransmitting said received data packet via said second external data port.

17. The method of claim 16, wherein said retransmitting is performed if said received data packet is not processed by said data handler.

18. The method of claim 15, wherein said predetermined function is a function of at least one of:
an IP destination address of said received data packet;
an IP source address of said received data packet; and
a session identifier associated with said received data packet.

19. The method of claim 18, wherein said predetermined function is a hash function.

20. A computer program product operative to perform the method of claim 15.

21. A computer program product operative to perform the method of claim 18.

22. A computer program product operative to perform the method of claim 19.

23. The cluster of claim 1, wherein a load-balancing node of said plurality is operative to perform the method of claim 15.

24. The cluster of claim 23, wherein every load-balancing node of said plurality is operative to perform the method of claim 15.
